(19) United States
(12) Patent Application Publication
(10) Pub. No.: US 2010/0201302 A1
(43) Pub. Date: Aug. 12, 2010

(54) CONTROL TECHNIQUES FOR MOTOR DRIVEN SYSTEMS

(75) Inventors: Colin LYDEN, Baltimore (IE); Javier CALPE-MARAVILLA, Algemesi (ES); Mark MURPHY, Kilmore (IE); Eoin ENGLISH, Pallasgreen (IE)

Correspondence Address: KENYON & KENYON LLP, 1500 K STREET, NW, WASHINGTON, DC, 20005-1257, US

(73) Assignee: ANALOG DEVICES, INC., Norwood, MA (US)

(21) Appl. No.: 12/367,938

(22) Filed: Feb. 9, 2009

(51) Int. Cl. G05B 11/26

(52) U.S. Cl. 318/629

(57) ABSTRACT

A drive signal for a motor-driven mechanical system has zero (or near zero) energy at an expected resonant frequency of the mechanical system. The drive signal may be provided in a series of steps according to a selected row of Pascal's triangle, wherein the number of steps equals the number of entries from the selected row of Pascal's triangle, each step has a step size corresponding to a respective entry of the selected row of Pascal's triangle, and the steps are spaced from each other according to a time constant determined by an expected resonant frequency of the mechanical system. Alternatively, the stepped drive signal may be provided as a series of uniform steps according to a selected row of Pascal's triangle, in which the steps are provided in a number of spaced intervals corresponding to the number of entries from the selected row of Pascal's triangle, each interval includes a number of steps corresponding to a respective entry from the selected row of Pascal's triangle and the intervals are spaced in time according to a time constant determined from the expected resonant frequency of the mechanical system. These techniques not only generate a drive signal with substantially no energy at the expected resonant frequency, they provide a zero-energy “notch” of sufficient width to tolerate systems in which the actual resonant frequency differs from the expected resonant frequencies.

### RELATED APPLICATION

This application is related to co-pending application “Control techniques for motor driven systems”, reference number 13641-387302, also filed on Feb. 9, 2009.

### BACKGROUND

The present invention relates to motor control and control of motor driven systems. In particular, it relates to control of motor driven systems that minimize ringing or ‘bounce’ in the mechanical systems that are under motor control.

Motor driven translational systems are commonplace in modern electrical devices. They are used when it is necessary to move a mechanical system within a predetermined range of motion under electrical control. Common examples can include autofocus systems for digital cameras, video recorders, portable devices having such functionality (e.g., mobile phones, personal digital assistants and hand-held gaming systems) and laser drivers for optical disc readers. In such systems, a motor driver integrated circuit generates a multi-value drive signal to a motor which, in turn, drives a mechanical system (e.g. a lens assembly, in the case of an auto-focus system). The motor driver generates the drive signal in response to an externally supplied codeword. The code word often is a digital value that identifies a location within the mechanical system's range of motion to which the motor should move the mechanical system. Thus, the range of motion is divided into a predetermined number of addressable locations (called “points” herein) according to the number of code words allocated to the range of motion. The drive signal is an electrical signal that is applied directly to the motor to cause the mechanical system to move as required.

Although the types and configurations of the mechanical systems typically vary, many mechanical systems can be modeled as a mass coupled to a spring. When a motor moves the mass according to the drive signal, the motion generates other forces within the system which can cause the mass to oscillate around the new location at some resonant frequency (f_{R}). For example, resonant frequencies of approximately 110 Hz have been observed in consumer electronic products. Such oscillation typically diminishes over time but it can impair performance of the device in its intended function by, for example, extending the amount of time that a camera lens system takes to focus an image or the time a disk reader takes to move to a selected track.

FIG. 1 is a simplified block diagram of a motor-driven system commonly used in lens drivers. The system includes an imaging chip 110, a motor driver 120, a voice coil motor 130 and a lens 140. The motor driver generates a drive signal to the voice coil motor in response to a code provided by the imaging chip. In turn, the voice coil motor moves the lens within its range of motion. Movement of the lens changes the way the lens focuses incoming light on a surface of the imaging chip, which can be detected and used to generate new codes to the motor driver. FIG. 2 is a frequency plot of possible response of the system of FIG. 1, illustrating a resonant frequency at frequency f_{R}.

FIG. 3 illustrates two drive signals generated by conventional motor drivers. A first drive signal is a step function, that changes from a first state to a second state as a discontinuous jump (FIG. 3(a)). The second illustrated drive signal is a ramp function that changes from the first state to the second state at a fixed rate of change (FIG. 3(b)). Both types of drive signals, however, cause the ringing behavior that impairs performance as noted above. FIG. 4, for example, illustrates ringing observed in one such mechanical system.

The inventors have observed that the ringing behavior of such motor-driven systems unnecessarily extends the settling times of such mechanical systems and degrades performance. Accordingly, there is a need in the art for such motor-driven systems that can be driven according to a digital codeword and avoids the oscillatory behavior noted in these systems.

### BRIEF DESCRIPTION OF THE DRAWINGS

FIG. 1 is a block diagram of an exemplary mechanical system suitable for use with the present invention.

FIG. 2 is a graph of frequency response of an exemplary mechanical system and oscillation that may occur during activation.

FIG. 3 illustrates conventional drive signals for mechanical systems.

FIG. 4 illustrates response of a mechanical system observed under a unitary step drive signal.

FIG. 5 illustrates a drive signal according to an embodiment of the present invention.

FIG. 6 is a graph illustrating height and position of the drive signal of FIG. 5.

FIG. 7 is a graph illustrating energy distribution by frequency of a drive signal of the present invention.

FIG. 8 illustrates response of a mechanical system observed under a drive signal such as shown in FIG. 5.

FIG. 9 is a block diagram of a system according to an embodiment of the present invention.

FIG. 10 is a graph illustrating energy distribution by frequency of another drive signal of the present invention.

FIG. 11 is a block diagram of a system according to an embodiment of the present invention.

FIG. 12 is a graph illustration other exemplary drive signals according to an embodiment of the present invention.

FIG. 13 is a simplified block diagram of a drive signal generator according to an embodiment of the present invention.

FIG. 14 is a graph illustrating another exemplary drive signal according to an embodiment of the present invention.

FIG. 15 is a simplified block diagram of a drive signal generator according to another embodiment of the present invention.

FIG. 16 is an exemplary graph illustrating typical displacement of a mechanical system (after settling) versus an applied drive signal.

FIG. 17 is a graph illustrating an exemplary drive signal according to a further embodiment of the present invention.

FIG. 18 is a block diagram of another mechanical system suitable for use with the present invention.

FIG. 19 is a simplified diagram of a MEMS switch system according to an embodiment of the present invention.

FIG. 20 is a simplified diagram of a MEMS mirror control system according to an embodiment of the present invention.

FIG. 21 is a simplified diagram of a haptic control system according to an embodiment of the present invention.

FIG. 22 is a simplified diagram of a disk reader according to an embodiment of the present invention.

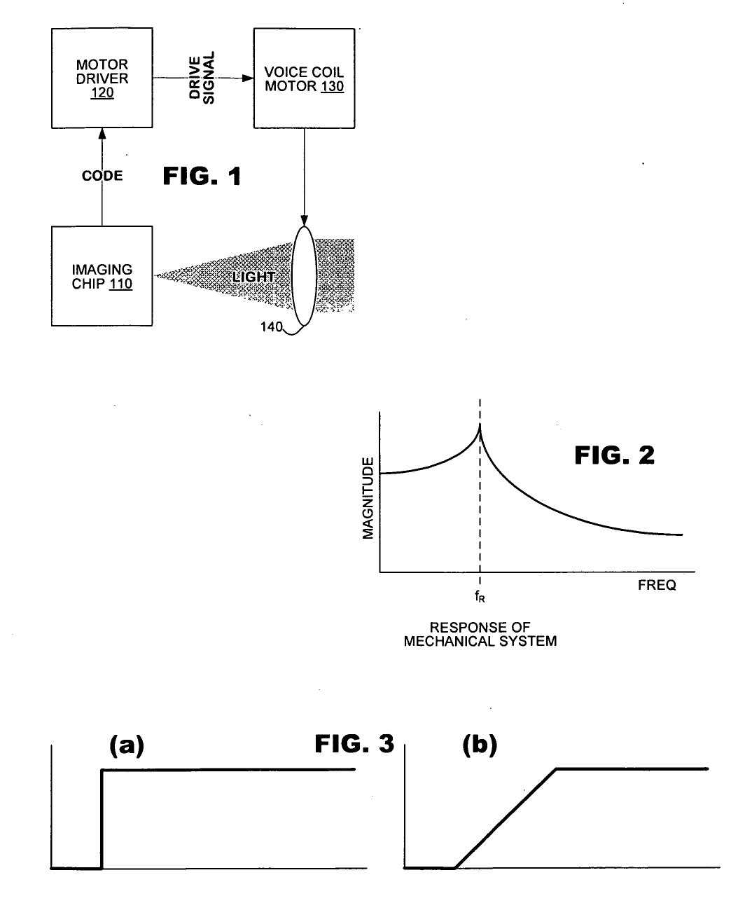

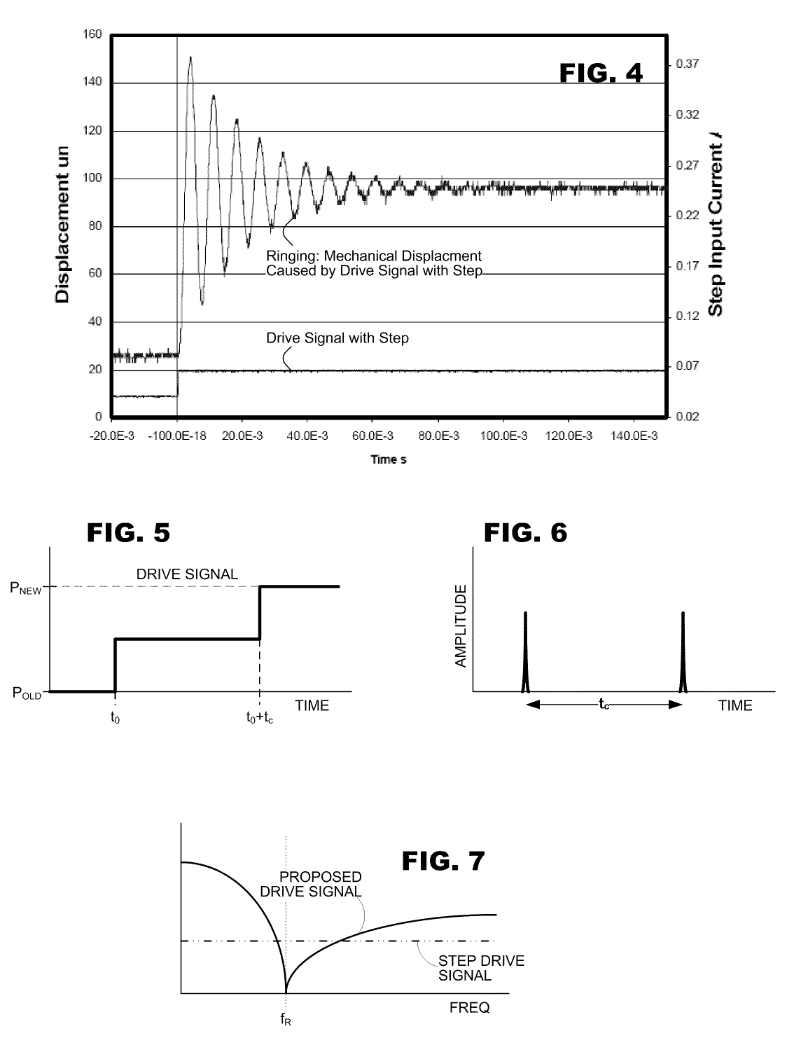

### DETAILED DESCRIPTION

Embodiments of the present invention provide a drive signal for a motor-driven mechanical system whose frequency distribution has zero (or near zero) energy at the expected resonant frequency of the mechanical system. The drive signal may be provided in a series of steps according to a selected row of Pascal's triangle, wherein the number of steps equals the number of entries from the selected row of Pascal's triangle, each step has a step size corresponding to a respective entry of the selected row of Pascal's triangle, and the steps are spaced from each other according to a time constant determined by an expected resonant frequency of the mechanical system. Alternatively, the stepped drive signal may be provided as a series of uniform steps according to a selected row of Pascal's triangle, in which the steps are spaced into a number of intervals corresponding to the number of entries from the selected row of Pascal's triangle and each interval includes a number of steps corresponding to a respective entry from the selected row of Pascal's triangle. These techniques not only generate a drive signal with substantially no energy at the expected resonant frequency, they provide a zero-energy “notch” of sufficient width to tolerate systems in which the actual resonant frequency differs from the expected resonant frequencies.

FIG. 5 is a graph illustrating an exemplary drive signal according to an embodiment of the present invention. The drive signal is a multi-stage step function that changes at times corresponding to a time constant:

$${t}_{c} ≅ \frac{1}{2 {f}_{R}} . \qquad Eq . 1$$

This translates to a drive signal with two steps, a first step at time t₀, having an amplitude corresponding to one half the level needed to traverse a distance separating a old position (P_{OLD}) from a new position (P_{NEW}) (ΔP=P_{NEW}−P_{OLD}). A second step may occur at time t₀+t_{c}, also having an amplitude corresponding to ½ΔP. FIG. 6 illustrates differential response of the drive signal of FIG. 5.

FIG. 7 is a graph illustrating energy distribution of the drive signal of FIG. 5 by frequency. As shown, the drive signal has non-zero energy distribution at frequencies both above and below the resonant frequency f_{R}. At the resonant frequency f_{R}, the drive signal has zero energy. This energy distribution minimizes energy imparted to the mechanical system and, therefore, avoids oscillation that may occur in such systems.

FIG. 7 also illustrates energy distribution that may occur in a drive signal generated from a unitary step function (phantom). In this graph, the system has non-zero energy at the resonant frequency f_{R}, which causes energy to be imparted to the mechanical system at this frequency. This non-zero energy component at the resonant frequency f_{R} is believed to contribute to the prolonged oscillation effect observed by the inventors.

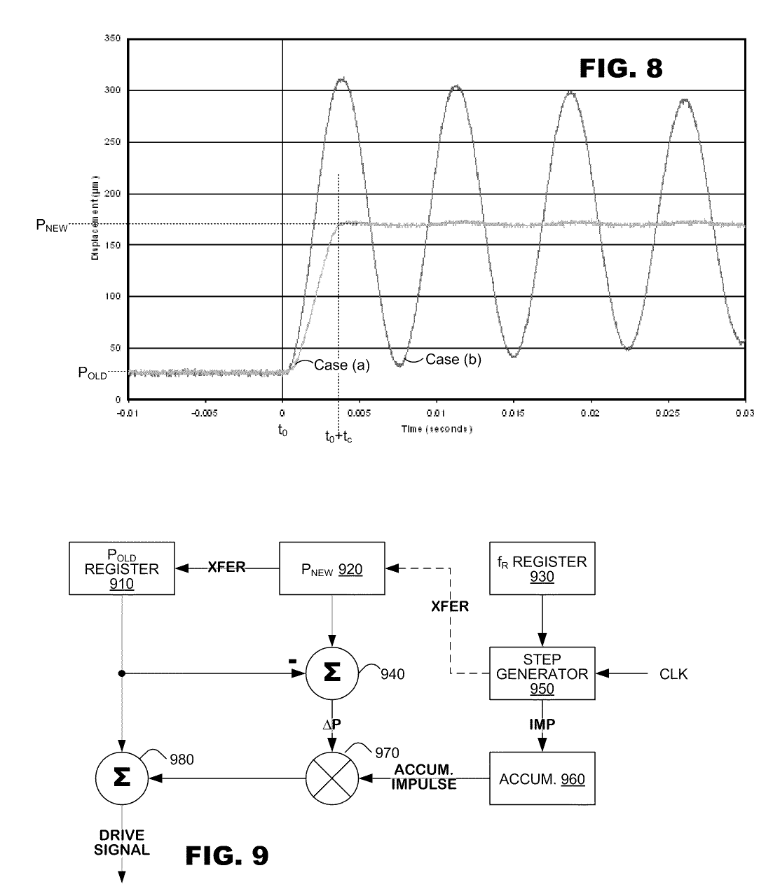

FIG. 8 is a graph that illustrates response of a mechanical system when driven by a drive signal having a shape as shown in FIG. 5 (case (a)). The mechanical system starts at a position P_{OLD} and moves to a position P_{NEW}. Activation pulses are applied at times t₀ and t₀+t_{C}. In this example, P_{OLD} corresponds to 27 μm (digital code 50) and P_{NEW} correspond to 170 μm (digital code 295), t₀ corresponds to t=0 and t_{C} corresponds to 3.7 ms.

FIG. 8 compares the mechanical system's response under the drive signal proposed herein (case (a)) against the response observed when driven by a drive signal according to a unitary step function (case (b)). Whereas in case (a) the mechanical system has settled on the new position P_{NEW} after about 4 ms, the same mechanical system exhibits prolonged oscillation in case (b). Even after 30 ms, the mechanical system continues to oscillate about the P_{NEW} position. Accordingly, the drive signal of FIG. 5 provides substantially faster settling times than conventional drive signals.

FIG. 9 is a block diagram of a system 900 according to an embodiment of the present invention. As shown, the system may include registers 910-930 for storage of data representing the old and new positions and the expected resonant frequency of the mechanical system. The system 900 may include a subtractor 940 to calculate ΔP from P_{NEW} and P_{OLD}. The system 900 further may include a step generator 950 that receives a system clock and generates pulses to an accumulator 960 according to timing determined from Eq. 1. The step generator 950 may generate pulses, for example, as shown in FIG. 6, having amplitudes each corresponding to one half the total distance to be traversed by the mechanical system. The accumulator 960 may sum the aggregate value of pulses generated by the step generator 950 and output the aggregate value to a multiplier 970 that also receives the ΔP value from the subtractor. Thus, the multiplier 970 generates a signal corresponding to the multi-step increments shown in FIG. 5. The output of the multiplier 970 may be input to an adder 980 that also receives the P_{OLD} value from register 910. Thus, the adder 980 may generate a time varying output signal sufficient to drive a mechanical system from a first position to a second position with minimal settling time.

When the mechanical system completes its translation from the old position to the new position, the old position may be updated. In the system illustrated in FIG. 9, after the step generator 950 generates its final step to the accumulator, it also may generate a transfer signal to registers 910 and 920 to cause the old position register 910 to be updated with data from the new position register 920.

The drive signal of FIG. 5 works well if the resonant frequency f_{R} of the mechanical system matches the ‘notch’ of the drive signal precisely (e.g. within ±3%). Unfortunately, system manufacturers often do not know the resonant frequency of their mechanical systems precisely. Moreover, particularly in consumer devices where system components must be made inexpensively, the resonant frequency can vary across different manufacturing lots of a common product. Thus, although a motor driver might be designed to provide a notch at an expected resonant frequency f_{RE}, there can be a substantial difference between the expected resonant frequency and the actual resonant frequency of the mechanical system (f_{RM}).

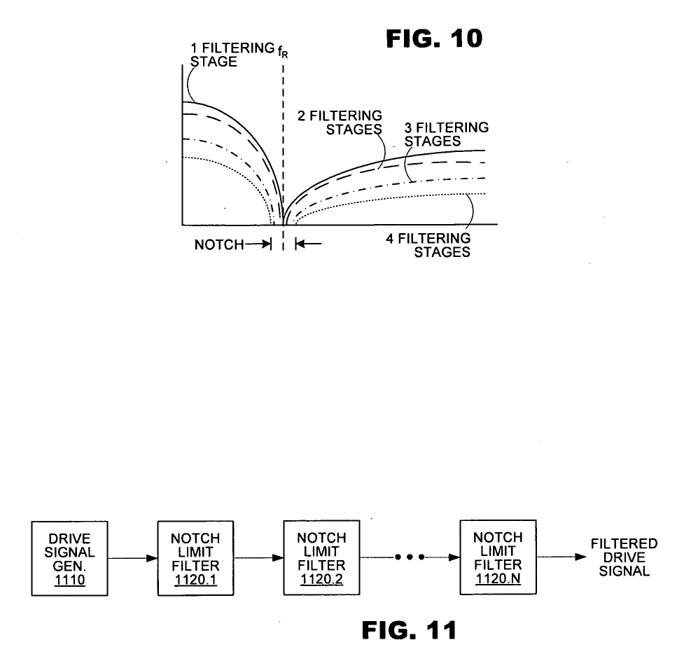

To accommodate such uses, the principles of the present invention may be expanded to expand the frequency notch to allow greater tolerance in the resonant frequencies used with such systems. One such expansion includes providing multiple layers of filtering to ‘widen’ the notch. FIG. 10 is a graph showing the expected effects of multiple layers of filtering. Four such layers of filtering are illustrated. Each such additional layer of filtering expands a “notch” of frequencies for which there is zero energy imparted to the system. Although each layer of filtering diminishes the aggregate amount of energy imparted to the system and, therefore, may cause slower movement by the mechanical system, such filtering may be advantageous to overall system operation by reducing settling times for mechanical systems even when the resonant frequency of such systems cannot be predicted with precision.

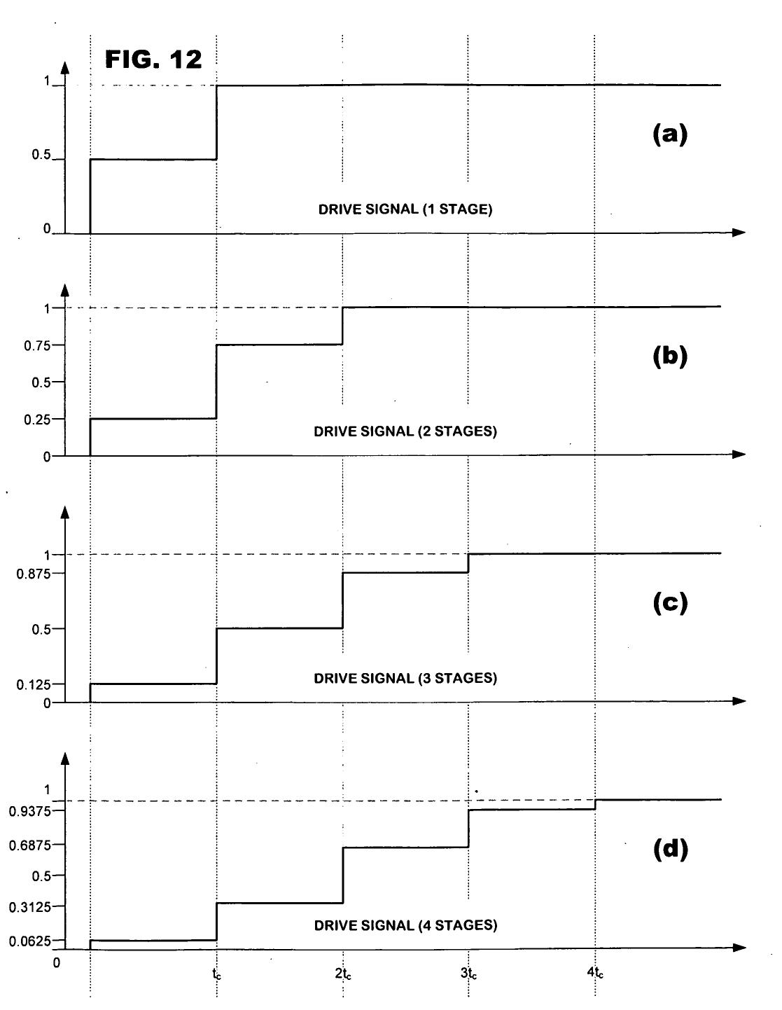

FIG. 11 illustrates a simplified block diagram of a system 1100 according to another embodiment of the present invention. The system includes a drive signal generator 1110 and one or more notch limit filters 1120.1-1120.N provided in series. A first filter 1120.1 in the system 1100 may accept a drive signal from the drive signal generator 1110. Each of the N filters (N≧1) may filter its input signal at an expected resonant frequency (f_{RE}). Because the filters are provided in cascade, the multiple filters may operate collectively to provide a filtered drive signal having a notch that is wider than would occur from a single filter system.

In the time domain, the additional levels of filtering provide a step response as follows:

TABLE 1

| | TIME | | | | |
|---|---|---|---|---|---|
| | 0 | T_{c} | 2T_{c} | 3T_{c} | 4T_{c} |
| 1 Stages | 1 | 1 | | | |
| 2 Stages | 1 | 2 | 1 | | |
| 3 Stages | 1 | 3 | 3 | 1 | |
| 4 Stages | 1 | 4 | 6 | 4 | 1 |

The output drive signals follow the step responses as shown in Table 1 after having been normalized (the steps are scaled so their sum equals 1). For example, with respect to a three-stage system, the step responses would be set to ⅛, ⅜, ⅜ and ⅛ at each of the times noted in Table 1. Drive signals are generated from a sum of the step responses over time. Thus, the drive signals of Table 1 may generate waveforms having the shape shown in FIG. 12.

The progression shown in Table 1 matches the progression of Pascal's Triangle. In an embodiment, an arbitrary N stage filter may be employed by using a progression taken from a corresponding N^{th} row of Pascal's Triangle. An arbitrary number of stages may be used as desired to protect against uncertainty in the expected resonant frequency of the mechanical system. Although any number of stages may be used, higher numbers of stages involve increased settling times and therefore the number of stages should be chosen with care.

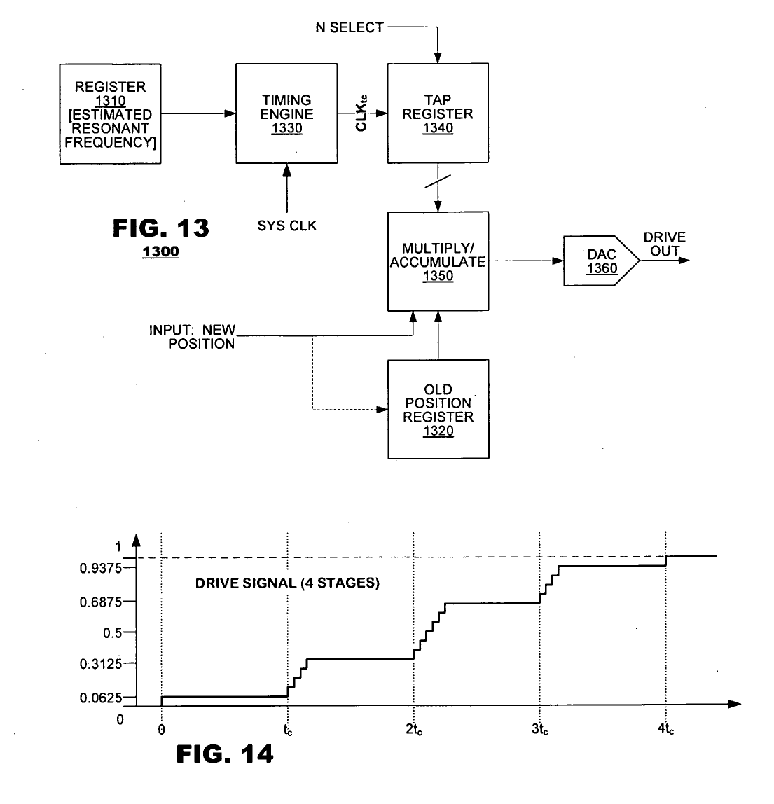

FIG. 13 is a block diagram of a signal generator 1300 according to an embodiment of the present invention. The signal generator 1300 may include a pair of registers 1310, 1320 to store data representing the estimated resonant frequency and the current position P_{OLD} of the mechanical system. A timing engine 1330 and a tap register 1340 may generate an output corresponding to an appropriate step pattern such as those illustrated in Table 1. Specifically, the timing engine 1330 may clock the tap register 1340 at a rate corresponding to time intervals t_{c} determined by the stored estimated resonant frequency. The tap register 1340 may store data representing the normalized values of Pascal's triangle. Based on a control signal (N select) identifying the row of Pascal's triangle to be applied, the tap register 1340 sequentially may output step values corresponding to each entry in the row on each cycle of the t_{C} clock.

A multiply accumulate (MAC) unit 1350 may receive data representing the new position P_{NEW}, the old position P_{OLD} and the step pattern data from the tap register 1340. Mathematically, the MAC 1340 may generate a digital drive code as:

Drive(t)=P_{OLD}+(P_{NEW}−P_{OLD})·Σstep(t), where

step(t) represents the step response of the selected pattern and t varies across all t_{c} intervals that are relevant for the selected pattern. A digital-to-analog converter (DAC) 1360 may generate an analog drive output signal from the MAC's digital output. The output signal may be generated as current or voltage.

The solution of FIG. 13 provides a wider notch as desired over the embodiment of FIG. 9 but does so at increased complexity. Normalized values of each row of Pascal's triangle must be stored in memory at the tap register or calculated dynamically. Such complexity may be avoided in another embodiment of the present invention in which timing misalignment is applied to the step graphs.

Consider the step response shown in Table 1. The response of any stage N (say n=3) is the sum of a prior stage N-1 and a replica of the same (stage N-1) delayed by a time constant t_{c}. For example:

TABLE 2

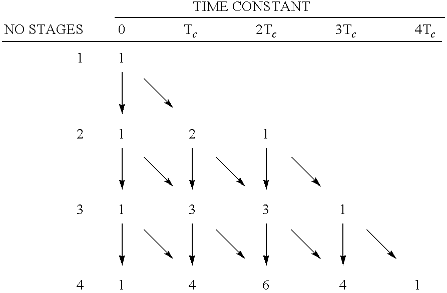

In an embodiment, the system generates step response patterns that represent replica signals that are misaligned with respect to each other slightly in time (shown as Δt in Table 3 below). The step response patterns may be represented as follows:

TABLE 3

| | | t_{c} | | | | 2t_{c} | | | | | | 3t_{c} | | | | |
|---|---|---|---|---|---|---|---|---|---|---|---|---|---|---|---|---|
| N | t0 | +0 | +Δt | +2Δt | +3Δt | +0 | +Δt | +2Δt | +3Δt | +4Δt | +5Δt | +0 | +Δt | +2Δt | +3Δt | 4tc |
| 1 | 1 | 1 | | | | | | | | | | | | | | |
| 2 | 1 | 1 | 1 | | | 1 | | | | | | | | | | |
| 3 | 1 | 1 | 1 | 1 | | 1 | 1 | 1 | | | | 1 | | | | 1 |
| 4 | 1 | 1 | 1 | 1 | 1 | 1 | 1 | 1 | 1 | 1 | 1 | 1 | 1 | 1 | 1 | 1 |

The step patterns may generate a drive signal such as shown in the example of FIG. 14. In the example illustrated, N=4.

In practice, the At time intervals may be provided by a system clock within the motor driver, which may be much faster than the t_{c} time interval calculated from the expected resonant frequency f_{R}. FIG. 14 is not drawn to scale.

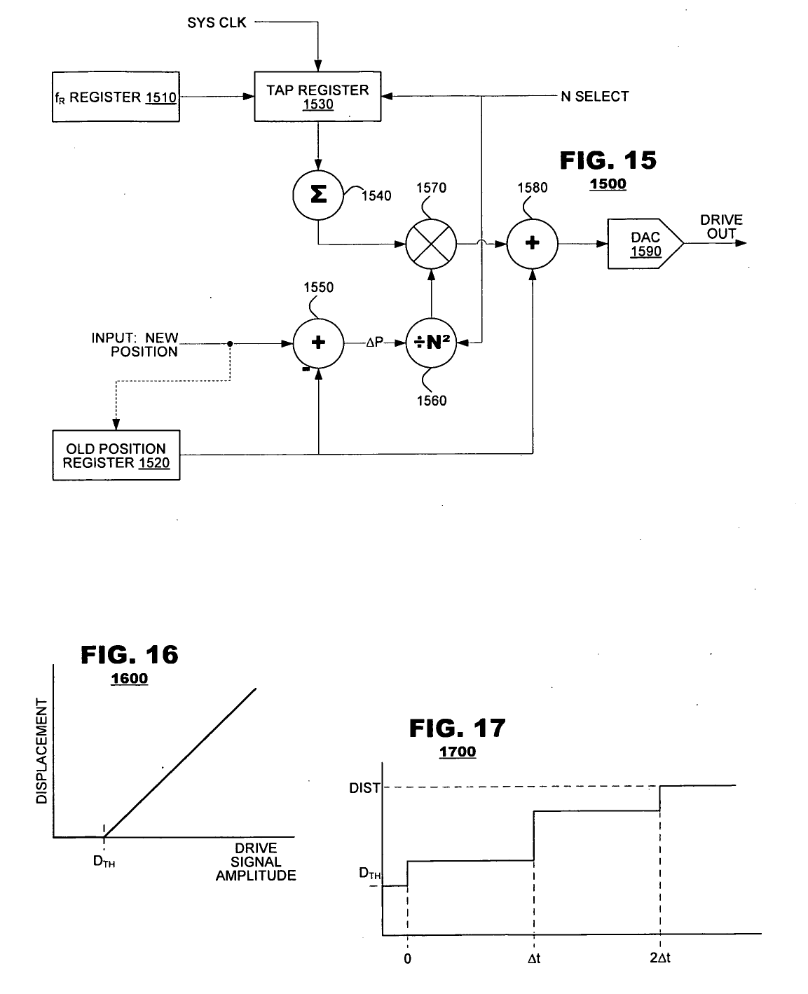

FIG. 15 illustrates a drive signal generator 1500 according to another embodiment of the present invention. The drive signal generator may include a pair of registers 1510, 1520 to store data representing the estimated resonant frequency of the mechanical system and a current position of the mechanical position (P_{OLD}). The drive signal generator may include a tap register 1530 that stores distributed step patterns such as those shown in Table 3. In response to each iteration of a system clock (corresponding to Δt), the tap register 1530 may shifts out a single bit of the step pattern. The tap register may include buffer bits (zeroes) corresponding to time intervals separating each time constant t_{c}. The shifted bits may be output to an accumulator 1540 which computes a running sum of pulses over time.

A subtractor 1550 may calculate ΔP from the old and new positions (ΔP=P_{NEW}−P_{OLD}). A divider may divide the ΔP by a factor 1/N², where N represents the row of Pascal's triangle currently in use. A multiplier 1570 and adder 1580 complete generation of the drive signal which, mathematically, may be represented as:

$$Drive ( t ) = {P}_{OLD} + \frac{1}{{N}^{2}} ( {P}_{NEW} - {P}_{OLD} ) \cdot \sum step ( t ) .$$

In this embodiment, the step(t) term again represents pulses from the tap register. In this embodiment, however, the tap register need not store normalized step values. Instead, the tap register may store single bit values (1s) at each of the Δt positions for which incremental contribution is required (see, Table 3). Within each of the N rows, the single bit steps sum to N². In this embodiment, the divider 1560 accomplishes normalization while permitting a simple implementation of the tap register. The DAC may generate an analog signal, either voltage or current, from the codeword output by the adder 1580.

While FIG. 15 illustrates the tap register 1530 being clocked by a system clock, the tap register alternatively may be clocked by a timing generator (not shown), that becomes active during a time period defined by each time constant t_{C} and, when active, clocks the tap register at a rate of Δt. When each burst of pulses concludes, the timing generator may be deactivated until the next t_{C} interval occurs. This second embodiment permits the size of the tap register to be made smaller but increases complexity of the clocking system.

The embodiment of FIG. 15 is advantageous because it provides for simpler implementation than the embodiment of Table 1 & FIG. 13. The step responses of the FIG. 14/Table 3 embodiment are uniform and, therefore, there is no need to develop fractional step response values as discussed with respect to Table 1. As with the FIG. 13 embodiment, the FIG. 15 embodiment also contributes to a wider notch as compared to the FIG. 5 embodiment.

Many mechanical systems do not move from the starting mechanical stop position immediately upon application of a drive signal. There usually are spring forces or other inertial forces that are not overcome until the amplitude of the drive signal reaches some threshold value D_{TH} (FIG. 16). The threshold value often is unknown and may vary from manufacturing lot to manufacturing lot.

To improve response times, when moving from a start position corresponding to a mechanical stop position, embodiments of the present invention may advance the drive signal to a value corresponding to the threshold drive signal D_{TH} (FIG. 17) and calculate ΔP as a difference between D_{TH} and the drive signal level sufficient to move the mechanical system to the destination position. When applying a drive signal to such a system, the drive signal may include the D_{TH} level applied immediately from the motor drive and a time-varying component corresponding to a stepped drive signal of one of the foregoing embodiments (FIGS. 5, 12 and/or 14) provided atop the D_{TH} level. The threshold drive D_{TH} may be estimated in a “blind” fashion (e.g. based on expected properties of the mechanical systems, which may or may not be true). Alternatively, the threshold value may be programmed into the system via a register.

The principles of the present invention find application in a variety of electrically-controlled mechanical systems. As discussed above, they may be used to control lens assemblies in auto-focus applications for cameras and video recorders such as shown in FIG. 1. It is expected that systems using the drive signals discussed herein will achieve improved performance because the lens assemblies will settle at new locations faster than may occur in systems with conventional drive signals. Accordingly, cameras and video recorders will generate focused image data faster than previously achieved, which we generate greater throughput.

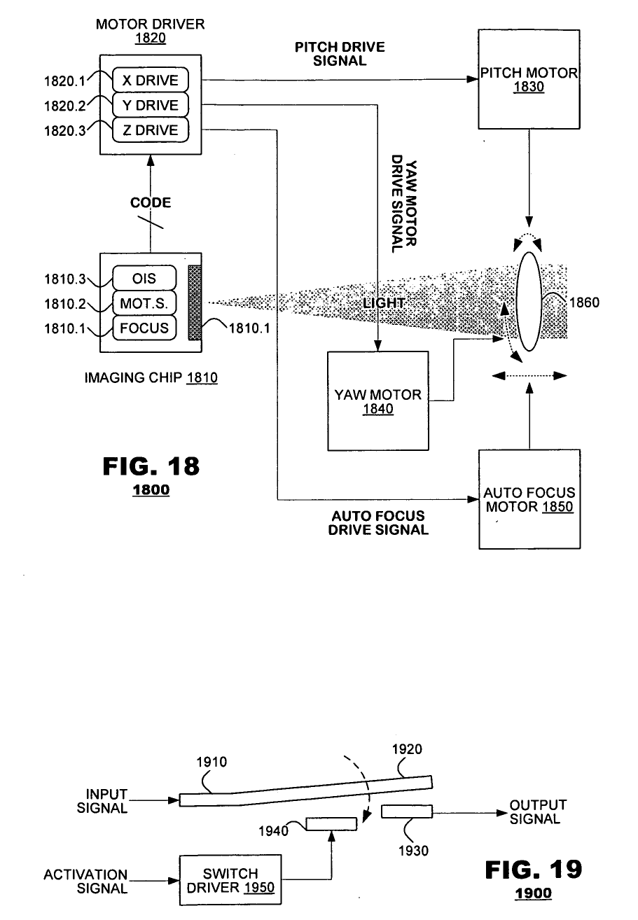

FIG. 18 illustrates another system 1800 according to an embodiment of the present invention. The system 1800 of FIG. 18 illustrates a lens control system with multiple dimensions of movement. This system, as with FIG. 1, may include an imaging chip 1810, a motor driver 1820, various motors 1830-1850 and a lens 1860. Each motor 1830-1850 may drive the lens in a multi-dimensional space. For example, as shown in FIG. 18, an auto focus motor 1830 may move the lens laterally with respect to the imaging chip 1810, which causes light to be focused in a light-sensitive surface 1810.1 of the chip 1810. A pitch motor 1840 may rotate the lens through a first rotational axis to control orientation of the lens 1860 in a first spatial dimension. A yaw motor 1850 may rotate the lens through a second rotational axis, perpendicular to the first rotational axis, to control orientation of the lens 1860 in another spatial dimension.

In the embodiment of FIG. 18, the imaging chip 1810 may include processing units to perform auto-focus control 1810.1, motion detections 1810.2 and optical image stabilization (OIS) 1810.3. These units may generate codewords for each of the drive motors 1830-1850, which may be output to the motor driver 1820 on an output line. In the embodiment shown in FIG. 18, the codewords may be output to the motor driver 1820 in a multiplexed fashion. The motor driver 1820 may include motor drive units 1820.1-1820.3 to generate analog drive signals for each of the drive motors 1830-1850. The analog drive signals may be generated according to the foregoing embodiments discussed in connection with FIGS. 5-15. As with the case of a one dimensional lens driver, it is expected that a multi-dimensional lens driver that is driven as shown in the foregoing embodiments will achieve faster settling times than lens drivers driven according to conventional drive signals.

The principles of the present invention finds application in other systems, for example, MEMS-based switches as shown in FIG. 19. Such systems may include a switch member 1910 that moves under control of a control signal between an open position and a closed position.

When closed, a movable ‘beam’ portion 1920 of the switch member 1910 is placed in contact with an output terminal 1930. The control signal is applied to the switch member 1910 through a control terminal 1940 that imparts electrostatic forces upon the switch member 1910 to move it from a normally open position to the closed position. In this regard, the operation of a MEMS switch is known.

According to an embodiment, a MEMS control system may include a switch driver 1950 that, responsive to an actuating control signal, generates a drive signal to the MEMS-switch having a shape such as shown in FIGS. 5, 12 or 14. MEMS switches will possess from which an expected resonant frequency and, by extension, the time constant t_{C} may be derived. The switch driver 1950 may apply steps having an aggregate amplitude sufficient to move the beam 1920 toward the output terminal 1930. At the conclusion of a final time constant, the switch driver 1950 may apply a final step to halt the beam 1920 at the closed position with minimal oscillation.

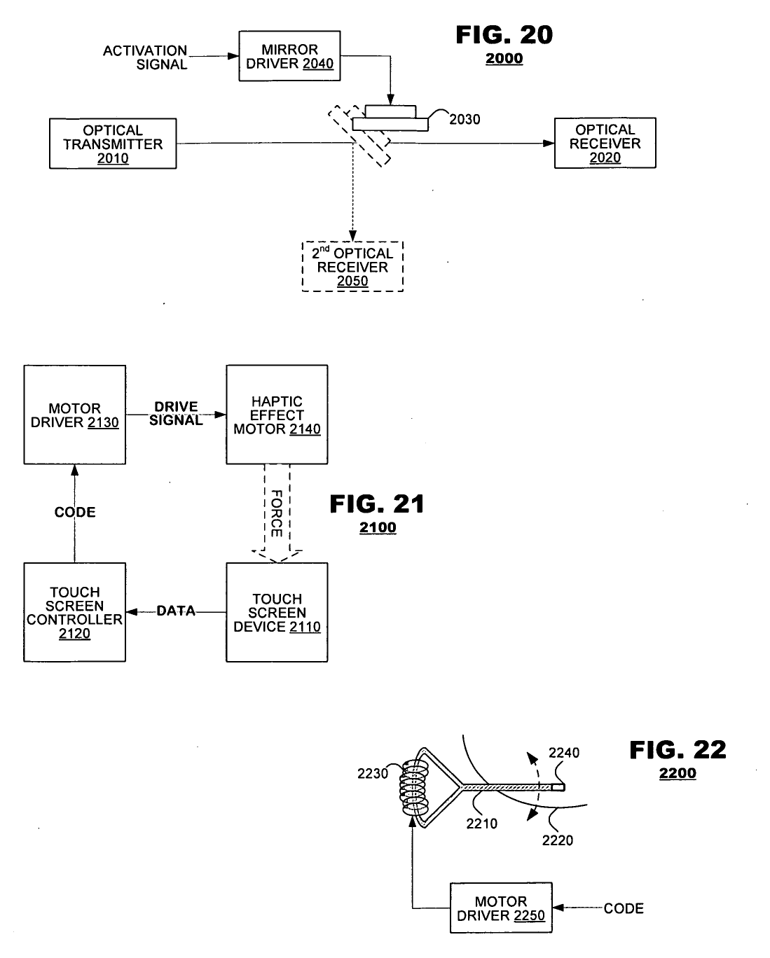

The principles of the present invention also may find application in optical MEMS systems, such as shown in FIG. 20. There, an optical transmitter 2010 and optical receiver 2020 are provided in a common optical path. A MEMS mirror 2030 may be provided along the optical path, which may translate from a first position to a second position under control of a drive signal. In a default state, for example, the MEMS mirror 2030 may be positioned out of the optical path between the transmitter 2010 and the receiver 2020. In an activated state, however, the MEMS mirror 2030 may move to obscure the optical path, which causes the transmitted beam of light to be blocked from reaching the receiver 2020.

According to an embodiment, a MEMS control system may include a mirror driver 2040 that, responsive to an actuating control signal, generates a drive signal to the MEMS-mirror 2030 to cause it to move from a default position to an activated position. The mirror 2030 may possess a mass from which an expected resonant frequency and, by extension, the time constant t_{C} may be derived. The mirror driver 2040 may apply steps having an aggregate amplitude sufficient to move the mirror 2030 toward the activated position. At the conclusion of a final time constant, the mirror driver 2040 may apply a final step to halt the mirror 2030 at the activated position with minimal oscillation.

The optical system 2000 optionally may include a second receiver 2050 provided along a second optical path that is formed when the mirror 2030 moves to the activated position. In this embodiment, the system 2000 may provide a routing capability for optical signals received by the optical system 2000.

The principles of the present invention may find application in touch sensitive sensor devices that use tactile or haptic feedback to confirm receipt of data. Haptic devices provide feedback that simulates the “click” of a mechanical button or other tactile feedback. Shown in FIG. 21, such devices 2100 may include a touch screen panel 2110 to capture data from an input device, commonly an operator's finger, a stylus or other object. The touch screen panel 2110 generates data to a touch screen controller 2120 that processes the panel data to derive a screen position on which the operator entered data. To provide the haptic feedback, the touch screen controller 2120 may generate a digital codeword to a motor driver, which generates a drive signal to a haptic motor controller 2130. The haptic motor controller 2130 may generate a drive signal to a haptic effect motor 2140 which imparts a force upon a mechanical device within the touch screen panel 2110 that generates the tactile feedback.

According to an embodiment, the motor driver 2130 may generate a drive signal to the haptic effect motor 2140 according to a shape such as shown in FIGS. 12 or 14. The haptic effect motor 2140 and associated mechanical components of the touch screen device may possess a mass from which an expected resonant frequency and, by extension, the time constant t_{C} may be derived. The motor driver 2130 may apply a series of steps according to a selected row of Pascal's triangle. Owing to a varying mass being controlled due to user interaction, the steps may originate from a deeper row (e.g., the 4^{th} row or deeper) of Pascal's triangle than for other applications. It is expected that the stepped pulse drive signal will generate tactile feedback within the touch screen device that begins and concludes sharply and, therefore, provide feedback sensations that strongly mimic mechanical devices.

The principles of the present invention also may find application in optical or magnetic disk readers, which may include swing arms or sled based readers. One common structure for disk readers is illustrated in FIG. 22, which illustrates a motor-driven swing arm 2210 provided over a disk surface 2220. The swing arm may include a motor coil 2230 mounted thereon which, when drive signals are supplied to it, generates magnetic flux that interacts with magnets (now shown) to move the swing arm across a range of motion. In this manner, a read head 2240 provided on the swing arm can address an identified track of information from the disk and read information.

According to an embodiment, a disk reader control system may include a motor driver 2250 that, responsive to a codeword, generates a drive signal to the motor coil 2230 having a shape such as shown in FIGS. 5, 12 or 14. Swing arms (and sleds) may possess inertia from which an expected resonant frequency f_{R} and, by extension, the time constant t_{C} may be derived. The motor driver 2250 may apply steps having an aggregate amplitude sufficient to move the disk reader to a new position. At the conclusion of a final time constant, the motor driver 2250 may apply a final step to halt the reader at the addressed position with minimal oscillation.

Several embodiments of the present invention are specifically illustrated and described herein. However, it will be appreciated that modifications and variations of the present invention are covered by the above teachings and within the purview of the appended claims without departing from the spirit and intended scope of the invention. Additionally, it will be appreciated that the signals illustrated above represent idealized forms of drive signals with instantaneous response; in practice, some amount of slew can be expected from a motor driver in actual operating conditions. Such effects have been omitted from the foregoing discussion so as not to obscure the principles of the present invention.

We claim:

1. A method for generating a drive signal to a motor-driven mechanical system, comprising:
applying a drive signal to the motor-driven mechanical system in a series of steps according to a selected row of Pascal's triangle, wherein:
the number of steps equals the number of entries from the selected row of Pascal's triangle,
each step has a step size corresponding to a respective entry of the selected row of Pascal's triangle, and
the steps are spaced from each other according to a time constant t_{C}, by:
$${t}_{c} ≅ \frac{1}{2 {f}_{R}}$$
where f_{R} is an expected resonant frequency of the mechanical system.

2. The method of claim 1, wherein the drive signal has substantially zero energy at the expected resonant frequency.

3. The method of claim 1, wherein a final step of the drive signal parks the mechanical system as the designation position with substantially no oscillation.

4. The method of claim 1, further comprising,
responsive to a codeword that identifies a destination position of the mechanical system, determining an amplitude of the drive signal having components representing: a) a start position of the mechanical system and b) a difference between the start position and the destination position,
wherein the amplitude component corresponding to the different is distributed across the time spaced steps of the drive signal.

5. The method of claim 1, wherein the codeword identifies an addressable position within a range of motion of the mechanical system.

6. The method of claim 1, further comprising, when a start position of the mechanical system is a rest position,
determining an amplitude of the drive signal having a) a first component corresponding to a drive signal level required to move the mechanical system from the rest position and b) a differential component corresponding to a difference between the first component and a drive signal level required to move the mechanical system to the destination position,
wherein the differential component is distributed across the time spaced steps of the drive signal, and
wherein the first component is applied in the first step of the drive signal.

7. The method of claim 1, wherein an amplitude of the steps is determined from a codeword generated by an image signal processor and the drive signal is applied to a lens drive motor.

8. The method of claim 1, wherein the mechanical system is a lens system having a multi-dimensional range of motion, the image signal processor generates codewords corresponding to each dimension and the method generates multiple drive signals, one corresponding to each of the codewords.

9. The method of claim 8, wherein there are three dimensions and three codewords, one for lateral movement of the lens system, one for pitch of the lens system and one for yaw of the lens system.

10. The method of claim 1, wherein an amplitude of the steps is determined from a codeword is generated by an touch panel controller and the drive signal is applied to a haptic effect motor coupled to a touch panel.

11. The method of claim 1, wherein an amplitude of the steps is determined from a codeword is generated by an disk controller and the drive signal is applied to a swing arm-based disk reader.

12. The method of claim 1, wherein an amplitude of the steps is determined from a codeword is generated by an disk controller and the drive signal is applied to a sled-based disk reader.

13. A method for generating a drive signal to a motor-driven mechanical system, comprising:
applying a drive signal to the motor-driven mechanical system in a series of steps according to a selected row of Pascal's triangle, wherein:
the steps are grouped into a number of intervals, wherein the number of intervals equals the number of entries from the selected row of Pascal's triangle,
each step has a uniform step size,
each interval includes a number of steps corresponding to a respective entry from the selected row of Pascal's triangle, and
the intervals are spaced from each other according to a time constant t_{C}, by:
$${t}_{c} ≅ \frac{1}{2 {f}_{R}}$$
where f_{R} is an expected resonant frequency of the mechanical system.

14. The method of claim 13, further comprising,
responsive to a codeword that identifies a destination position of the mechanical system, determining an amplitude of the drive signal having components representing: a) a start position of the mechanical system and b) a difference between the start position and the destination position,
wherein the step size is determined from the difference component.

15. The method of claim 13, further comprising, when a start position of the mechanical system is a rest position,
determining an amplitude of the drive signal having a) a first component corresponding to a drive signal level required to move the mechanical system from the rest position and b) a differential component corresponding to a difference between the first component and a drive signal level required to move the mechanical system to the destination position,
wherein the step size is determined from the difference component, and
wherein the first component is applied in the first step of the drive signal.

16. The method of claim 13, wherein an amplitude of the steps is determined from a codeword generated by an image processing system and the drive signal is applied to a lens drive motor.

17. The method of claim 13, wherein an amplitude of the steps is determined from a codeword is generated by an touch panel controller and the drive signal is applied to a haptic effect motor coupled to a touch panel.

18. The method of claim 13, wherein an amplitude of the steps is determined from a codeword is generated by an disk controller and the drive signal is applied to a swing arm-based disk reader.

19. The method of claim 13, wherein an amplitude of the steps is determined from a codeword is generated by an disk controller and the drive signal is applied to a sled-based disk reader.

20. A drive signal generator, comprising:
a tap register storing patterns representing rows of Pascal's triangle and responsive to a control signal identifying a selected row;
a timing engine to drive the tap register at time intervals corresponding to a time constant t_{C}:
$${t}_{c} ≅ \frac{1}{2 {f}_{R}}$$
where f_{R} is an expected resonant frequency of a mechanical system to be driven by the drive signal generator; and
an accumulator, responsive to the tap register and to data representing a start position and a destination position of the mechanical system to generate a stepped drive signal, wherein:
a number of steps equals the number of entries from the selected row of Pascal's triangle,
each step has a step size corresponding to a difference between the start position and destination position and to a respective entry of the selected row of Pascal's triangle, and
the steps are spaced from each other according to the time constant t_{C}; and
a digital to analog converter to generate an analog representation of the stepped drive signal.

21. The drive signal generator of claim 20, wherein the digital to analog converter generates an analog voltage.

22. The drive signal generator of claim 20, wherein the digital to analog converter generates an analog current.

23. The drive signal generator of claim 20, wherein the drive signal has substantially zero energy at the expected resonant frequency.

24. A drive signal generator, comprising:
a tap register storing patterns representing rows of Pascal's triangle, the patterns each containing intervals of a number of uniform steps, the number of intervals corresponding to the number of entries of Pascal's triangle, the number of steps in each interval corresponding to the value of a respective entry of Pascal's triangle;
an adder, responsive to output from the tap register and to data representing a start position and a destination position of the mechanical system to generate a stepped drive signal, wherein the stepped drive signal has an amplitude corresponding to an accumulated number of steps output from the tap register and further corresponding to a difference between a start position and a destination position,
a timing engine to drive the tap register, wherein the timing engine causes the tap register to output steps in intervals, the intervals are spaced from each other by a time constant t_{C}, by:
$${t}_{c} ≅ \frac{1}{2 {f}_{R}}$$
where f_{R} is an expected resonant frequency of the mechanical system, and steps within each interval are spaced from each other by a time constant shorter than t_{C}.

25. A method of driving a motor-driven mechanical system, comprising:
responsive to a codeword identifying a destination position of the mechanical system, generating a multi-step drive signal, each step offset from a neighboring step by a time t_{C}:
$${t}_{c} ≅ \frac{1}{2 {f}_{R}}$$
where f_{R} is an expected resonant frequency of the mechanical system,
wherein an amplitude of each step is derived from a selected row of Pascal's triangle and a difference between the destination position and the start position.

26. A method of driving a motor-driven mechanical system, comprising:
responsive to a codeword identifying a destination position of the mechanical system, generating a stepped drive signal in a plurality of intervals, each interval offset occurring from a neighboring interval by a time t_{C}:
$${t}_{c} ≅ \frac{1}{2 {f}_{R}}$$
where f_{R} is an expected resonant frequency of the mechanical system,
wherein each step has a uniform amplitude and a number of steps within each interval is derived from a selected row of Pascal's triangle.
